(19) United States
(12) Patent Application Publication
(10) Pub. No.: US 2011/0131262 A1
(43) Pub. Date: Jun. 2, 2011

(54) FLOATING POINT DIVIDER AND INFORMATION PROCESSING APPARATUS USING THE SAME

(76) Inventor: SATOSHI NAKAZATO, Tokyo (JP)

(21) Appl. No.: 12/957,907

(22) Filed: Dec. 1, 2010

(30) Foreign Application Priority Data
Dec. 2, 2009 (JP) 2009-274930

(51) Int. Cl. G06F 7/487; G06F 5/01

(52) U.S. Cl. 708/209; 708/504

(57) ABSTRACT

A floating point divider includes a mantissa repetitive processing unit and an operation execution control unit. The mantissa repetitive processing unit calculates a quotient and a partial remainder by a digit-recurrence process for a mantissa of a dividend of an input operand. The operation execution control unit determines a bit value at a specified position uniquely specified based on a radix of an operation execution process with respect to the partial remainder. The mantissa repetitive processing unit reduces the number of digit-recurrence processes by calculating a quotient and a remainder based on a determining result of the operation execution control unit. The number of bits of the quotient is double of that of a quotient calculated once every the digit-recurrence process. The number of left-shift processes processed on the remainder is double of that of a remainder calculated once every the digit-recurrence process.

### INCORPORATION BY REFERENCE

This application is based upon and claims the benefit of priority from Japanese patent application No. 2009-274930 filed on Dec. 2, 2009, the disclosure of which is incorporated herein in its entirety by reference.

### TECHNICAL FIELD

The present invention relates to a floating point divider and an information processing apparatus using the same. More particularly, the present invention relates to a digit-recurrence (or subtract-and-shift) floating point divider for a binary floating point number and an information processing apparatus using the same.

### BACKGROUND ART

A floating point divider such as a digit-recurrence floating point divider, which complies with the IEEE Standard for Binary Floating-Point Arithmetic (IEEE 754), is known.

Here, the digit-recurrence division is generally represented by the following recurrence formula.

R(j+1)=r×R(j)−q(j)×D (1)

In the formula, j indicates the exponent of the recurrence formula, r indicates the radix, D indicates the divisor, q (j) indicates the j-th decimal place of the quotient, R(j) indicates the partial remainder calculated at the previous time (the j-th time), and R (j+1) indicates the partial remainder calculated at the present time (the (j+1)-th time).

Here, there is constraint on the relation between the partial remainder R(j+1) and the divisor D as shown blow.

R(j+1)<D (2)

The execution procedure of the digit-recurrence division is that the quotient q (j) is firstly determined so as to satisfy the formula (2) and then the partial remainder R(j+1) is calculated by executing the formula (1).

For example, when the radix is assumed to be 2, the determination of the quotient in this execution procedure is represented by the followings.

D≦2×R(j)→q(j)=1

0≦2×R(j)<D→q(j)=0

Therefore, when the formula (1) is considered, the execution procedure of the digit-recurrence division based on the radix of 2 is as follows.

2×R(j)−D≧0→q(j)=1, R(j+1)=2×R(j)−D

2×R(j)−D<0→q(j)=0, R(j+1)=2×R(j)

In light of the above-mentioned information, an operation of a mantissa repetitive processing unit in the conventional binary digit-recurrence floating point divider based on the radix of 2 will be described below. FIG. 1 is a block diagram showing a configuration of the mantissa repetitive processing unit in the conventional binary digit-recurrence floating point divider based on the radix of 2. Two floating point operands (Y: dividend, Z: divisor) supplied to this floating point divider are received by two registers (FFs), respectively. After that, the two floating point operands are supplied to data alignment units called Unpackers 640 and 641, respectively. In each of the Unpackers 640 and 641, only mantissa is extracted from the floating point operand and other process is executed, in which the sign bit (s) and the hidden bit (s) are supplemented and the decimal points of the single-precision floating point and the double-precision floating point are aligned. Generally, the process is called the mantissa preprocess.

The data outputted from the Unpacker 640 for the dividend Y is supplied to a first selector 615 controlled by using a selection control signal 605 outputted from an operation execution control sequencer 600. The first selector 615 selects the output data from the Unpacker 690 only at the first time of the mantissa digit-recurrence process after the operation execution starts. The data outputted from the first selector 615 is stored in a register 620. On the other hand, the data outputted from the Unpacker 64i for the divisor Z is supplied to and stored in a register 621. The register 621 for the divisor Z continues to store the value of the divisor Z during the operation execution.

The subtracter 630 executes the subtraction process on the data of the register 620 for the dividend Y and the data of the register 621 for the divisor Z. The carry bit outputted from the subtracter 630 is supplied to a second selector 635 as a selection control signal through an inverter 634. The second selector 635 selects one of the output of the subtracter 630 and the output of the register 620 for the dividend. The output of the second selector 635 becomes the other input of the first selector 615 through a 1-bit left shifter 610. The first selector 615 continues to select the output data from the 1-bit left shifter 610 at the second time or later of the mantissa digit-recurrence process after the operation execution starts. The data outputted from the first selector 615 is stored in the register 620 as the partial remainder. The processing unit having the foregoing configuration is the mantissa repetitive processing unit 650.

Since the partial remainder stored in the register 620 holds “2×R(j)” caused by the 1-bit left shifter 610, the subtracter 630 can calculate “2×R(j)−D”. The carry bit outputted from the subtracter 630 corresponds to the sign bit of the result of “2×R(j)−D”. When the sign bit is the bit value of 0, it indicates “2×R(j)−D≧0”. In this case, the result of inverting the carry bit by the inverter 634 is set to the quotient of the division. In addition, the second selector 635 selects “2×R(j)−D” outputted from the subtracter 630 as the partial remainder of the next time. On the other hand, when the sign bit is the bit value of 1, it indicates “2×R(j)−D<0”. In this case, the result of inverting the carry bit by the inverter 634 is set to the quotient of the division. In addition, the second selector 635 selects “2×R(j)” outputted from the register 620, which stores the partial remainder, as the partial remainder of the next time. As described above, the mantissa repetitive processing unit 650 realizes the execution procedure of the digit-recurrence division based on the radix of 2.

The quotient, in which the carry bit of the subtracter 630 is inverted by the inverter 634, is stored in a quotient register 680 every one bit in response to a strobe signal 606 outputted from the operation execution control sequencer 600. The output of the second selector 635 is stored in a remainder register 681 as a final remainder after all of the mantissa digit-recurrence process is completed in response to the strobe signal 606 outputted from the operation execution control sequencer 600. The outputs of the quotient register 680 and the remainder register 681 are supplied to a rounding processing unit 660. The rounding processing unit 660 executes the rounding process on the outputs.

Next, an operation of the mantissa repetitive processing unit 650 in the binary digit-recurrence floating point divider shown in FIG. 1 will be described below. FIG. 2 is a flowchart showing an operation of the mantissa repetitive processing unit 650 in the binary digit-recurrence floating point divider shown in FIG. 1. The operation is generally implemented as hardware in the operation execution control sequencer 600. Each operation result of each step in the flowchart is outputted as a control signal for the mantissa repetitive processing unit 650.

When the operation execution starts (STEP 700), an initial value of the number of times of the mantissa digit-recurrence process is set first (STEP 710). Generally, the initial value at this STEP is 27 times when an operation data is a single-precision floating point data (32 bits) and 56 times when an operation data is a double-precision floating point data (64 bits). Next, the mantissa repetitive process is executed (STEP 720). This process is to obtain a quotient of 1 bit and a partial remainder by using the mantissa digit-recurrence process. Subsequently, after the end of the mantissa repetitive process (STEP 720), it is determined whether or not the number of times of the mantissa digit-recurrence process is 0 (STEP 730). If the number of times of the mantissa digit-recurrence process is 0 (STEP 730: Yes), the rounding process is executed (STEP 780) and the operation execution ends (STEP 790). On the other hand, if the number of times of the mantissa digit-recurrence process is not 0 (STEP 730: No), 1 is subtracted from the number of times of the mantissa repetitive process (STEP 760), the partial remainder is shifted to the left by 1 bit (the partial remainder is doubled) (STEP 765) and the operation returns to the mantissa repetitive process (STEP 720).

As a related art, Japanese Patent No. JP2835153 (corresponding to U.S. Pat. No. 5,105,378A) discloses the technique of the basic configuration of a digit-recurrence high-radix divider using the redundant binary system. The JP2835153 shows that the high-radix divider has an advantage over a convergence type division algorithm such as the Newton-Raphson method. By using this high-radix divider, the number of times of the digit-recurrence process (occupying most of an operation TAT (Turn Around Time)) is uniquely determined based on a radix and an operation precision.

Japanese Patent Publication No. JP-A-Showa 56-103740 discloses a decimal dividing apparatus. The decimal dividing apparatus reads an operation data from a memory, executes a digit-recurrence dividing process, determines whether or not a remainder is 0 during the execution, stops the quotient calculation if the remainder is 0, generates 0 digit to the figure(s) in which a quotient is not calculated, and writes the result of the quotient calculation into the memory.

Japanese Patent Publication No. JP-P2000-34783.6A (corresponding to U.S. Pat. No. 6,625,633 (B1)) discloses a divider and a method with a high-radix. The high-radix divider compares multiples B, 2B, and 3B of a divisor B with a remainder R in parallel in two comparators and a three-input comparator and performs radix 4 division by finding a quotient 2 bits at a time. That is, in the high-radix divider using the restoring division method, for example, the radix of 4 is used, the three subtraction process of (R−3B), (R−2B) and (R−B) between the divisor B and the remainder R is executed usually and a quotient and next divisor is determined based on the sign bits of the results.

Japanese Patent Publication No. JP-P2003-084969A (corresponding to US Patent Publication No. US2003050948(A1)) discloses a floating-point remainder computing unit, an information processing apparatus and a storage medium. The floating-point remainder computing unit is configured such that the floating-point sum of product computing of (a dividend−an integer quotient×divisor), which is necessary to calculate a remainder, is executed by a simple circuit compared with a conventional method in the floating-point remainder computing. That is, in the floating-point remainder computing unit, the quotient, which is calculated by a floating-point divider based on the floating-point numbers A and B, is rounded to the integer C, and then, A−B×C is calculated to obtain a remainder of the two floating-point numbers A and B.

Japanese Patent Publication No. JP-A-Heisei 06-075752 (corresponding to U.S. Pat. No. 5,343,413(A)) discloses a leading one anticipator and a floating point addition/subtraction apparatus. The leading one anticipator is a bit-discard amount anticipator anticipates a bit-discard amount within a one-bit error. A borrow propagator propagates a borrow from a least significant bit side. A selector modifies an output of the bit-discard amount anticipator to an accurate bit shift amount required at a normalization and outputs it, using information of the borrow propagator. That is, in the Leading-Zero Anticipatory (LZA) of a mantissa bit-discard/a normalization bit-discard in the floating-point adder-subtractor, since a 1 bit anticipation error occurs usually, a correction (1 bit alignment of mantissa) of the anticipation error is executed in the rounding process. The leading one anticipator is related to the bit-discard amount anticipator in which the anticipation error does not occur.

Japanese Patent Publication No. JP-A-Heisei 09-223016 (corresponding to U.S. Pat. No. 5,838,601(A)) discloses an arithmetic processing method and arithmetic processing device. In the arithmetic processing method, the possibility that an arithmetic exception occurs in the arithmetic result obtained through an arithmetic process is judged in the middle of the arithmetic process. When it is judged that there is a possibility, transmitting of an arithmetic end signal to an instruction control unit is inhibited. The arithmetic process with the possibility is executed by means of another arithmetic unit different from a dedicated arithmetic unit. Thereafter the arithmetic end signal regarding the arithmetic process is transmitted to the instruction control unit.

However, the inventor has now discovered that the conventional binary digit-recurrence floating point divider has following problems.

The first problem is that too much operation TAT is required to obtain a division result. The first reason of the first problem is as follows. In the floating point divider, when the operation result with the double-precision is necessary, the quotient of 56 bits is required considering the execution of the rounding process. However, the digit-recurrence floating point divider based on the radix of 2 as shown in FIG. 1 can obtain the quotient of only one bit per one digit-recurrence. Therefore, to obtain the quotient of 56 bits, the digit-recurrence process should be repeated 56 times. The second reason of the first problem is as follows. The digit-recurrence process includes the process that the divisor of 56 bits are subtracted from the partial remainder of 56 bits and then one of the subtraction result and the original partial remainder is selected based on the sign of the subtraction result as a partial remainder for the next digit-recurrence process. Therefore, this process is the critical path to determine the operating frequency.

On the other hand, as the method to improve the operation TAT by executing a plurality of the digit-recurrence processes in single clock cycle to reduce delay time of this critical path, there is the method using the redundant binary (SD: Signed Digit). FIGS. 3A and 3B are block diagrams showing a configuration of the mantissa repetitive processing unit in the binary digit-recurrence floating point divider. Two floating point operands (Y: dividend, Z: divisor) supplied to this floating point divider are received by two registers (FFs), respectively. After that, the two floating point operands are supplied to data alignment units called Unpackers 840 and 841, respectively. The data outputted from the Unpacker 840 for the dividend Y is supplied to a first selector 816 controlled by using a selection control signal 805 outputted from an operation execution control sequencer 800. The first selector 816 selects the output data from the Unpacker 840 only at the first time of the mantissa digit-recurrence process after the operation execution starts. The data outputted from the first selector 816 is stored in a register 821 as a SUM digit of the signed digit. On the other hand, the data outputted from the Unpacker 841 for the divisor Z is supplied to and stored in a register 822. The register 822 for the divisor Z continues to store the value of the divisor Z during the operation execution. In addition, there is a second selector 815 that selects an output data having all bit values of 1 only at the first time of the mantissa digit-recurrence process after the operation execution starts, in response to a selection control signal 805 outputted from an operation execution control sequencer 800. The data outputted from the second selector 815 is stored in a register 820 as the SIGN digit of the signed digit.

The data in the SIGN digit register 820 for the dividend Y is doubled by a 1-bit left shifter 810, and then outputted to signed digit adders 830 and 831. The data in the SUM digit register 821 for the dividend Y is doubled by a 1-bit left shifter 811, and then outputted to the signed digit adders 830 and 831. The signed digit adders 830 and 831 calculates “2×R(j)+D” and “2×R(j)−D”, respectively, based on the data outputted from the 1-bit left shifters 810 and 811 and the data in the register 822 for the divisor Z. On the other hand, the higher-order 3 bits (in the case of the radix of 2; bits more than 3 are required in the case of the radix equal to or more than 4) of each of the SIGN digit and the SUM digit of the dividend Y, which are doubled by the 1-bit left shifters 810 and 811, are transformed from the signed digit to the binary by a SD-BIN transformer 833 and outputted to a quotient determination logic unit 834. The quotient determination logic unit 839 determines and outputs the SIGN bit and the SUM bit of the quotient of 1 bit expressed by using the signed digit system. Further, the quotient generated by the quotient determination logic unit 834 can take one of three values of +1, 0 and −1. Therefore, a selector 835 and a selector 836 respectively select one of “2×R(j)+D”, “2×R(j)” and “2×R(j)−D” as the SIGN digit and the SUM digit of the partial remainder for the next digit-recurrence process. A first mantissa repetitive processing unit 850 is the processing unit including above-mentioned configuration elements.

Similarly, the SIGN digit of the partial remainder from the first mantissa repetitive processing unit 850 is supplied to the signed digit adders 890 and 891 through a 1-bit left shifter 870. The SUM digit of the partial remainder from the first mantissa repetitive processing unit 850 is supplied to the signed digit adders 890 and 891 through a 1-bit left shifter 871. In addition, the higher-order 3 bits of each of the SIGN digit and the SUM digit of the partial remainder are transformed from the signed digit to the binary by a SD-BIN transformer 893 and outputted to a quotient determination logic unit 894. The quotient determination logic unit 894 determines and outputs the SIGN bit and the SUM bit of the quotient of 1 bit expressed by using the signed digit system. A selector 895 and a selector 896 respectively select the SIGN digit and the SUM digit of the partial remainder with respect to the next digit-recurrence process. A second mantissa repetitive processing unit 851 is the processing unit including above-mentioned configuration elements.

The SIGN bit and the SUM bit of the quotient of 1 bit expressed by using the signed digit system, which are outputted from both of the first mantissa repetitive processing unit 850 and the second mantissa repetitive processing unit 851, are stored every 2 bits in a SIGN digit register 880 and a SUM digit register 881 for the quotient, respectively, in response to a strobe signal 806 outputted from the operation execution control sequencer 800. The SIGN digit and the SUM digit for the partial remainder, which are outputted from the SIGN digit selector 895 and the SUM digit selector 896 for the partial remainder of the second mantissa repetitive processing unit 851, are stored in a SIGN digit register 882 and a SUM digit register 883 for the remainder as the final remainder, in response to a strobe signal outputted from the operation execution control sequencer 800, after all of the mantissa digit-recurrence process is completed. The outputs of the quotient SIGN digit register 880, the quotient SUM digit register 881, the remainder SIGN digit register 882 and the remainder SUM digit register 883 are supplied to a rounding processing unit 860. The rounding processing unit 860 transfers the outputs from the signed digits to the binaries and executes the rounding process on them.

The mantissa repetitive processing unit for the signed digit can drastically reduce logic stages in comparison with the critical path of the mantissa repetitive process for the binary, because, as for the carry propagation in the signed digit adder, only single digit to the adjacent bit is propagated. Therefore, as shown in FIGS. 3A and 3B, the first mantissa repetitive processing unit 850 and the second mantissa repetitive processing unit 851 can be implemented with the cascade connection within single clock cycle. Consequently, the digit-recurrence process can be performed twice per clock cycle to obtain the quotient of 2 bits.

Moreover, FIGS. 3A and 3B show the case using the radix of 2. Using the radix of 4, the quotient of 2 bits can be obtained by performing single digit-recurrence process. Using the radix of 8, the quotient of 3 bits can be obtained by performing single digit-recurrence process. In the above example, the units are implemented so that the digit-recurrence process using the radix of 2 is performed twice per clock cycle. Besides, the units can be increased so that the digit-recurrence process is performed three times or four times per clock cycle. Consequently, the number of bits of the quotient, which is obtained per clock cycle, can be increased. The units can be combined and implemented so that the digit-recurrence process using the radix of 4 is performed twice per clock cycle.

However, the digit-recurrence floating point divider using the signed digit as mentioned above has following problems.

The second problem of the conventional binary digit-recurrence floating point divider is that too much difficulty exists in the divider designing. The reason of the second problem is as follows. Even though heightening of the radix for the operation and cascade-implementing of the digit-recurrence processes for single clock cycle are performed to reduce the operation TAT, the influence on the delay increase and the hardware increase are relatively great despite reducing of the critical path delay per digit-recurrence process due to the signed digit. Thus, too much difficulty exists in the divider designing such that the custom design or the Domino circuit design is required to improve the operation frequency.

### SUMMARY

Therefore, an object of the present invention is to provide a floating point divider and an information processing apparatus using the same which can reduce the operation TAT to improve the performance and decrease the electric power consumption while avoiding the hardware significant increase, the critical path delay increase and design difficulty increase.

In order to achieve an aspect of the present invention, the present invention provides a floating point divider, which is a binary digit-recurrence floating point divider, including: a mantissa repetitive processing unit; and an operation execution control unit. The mantissa repetitive processing unit calculates a quotient and a partial remainder by a digit-recurrence process for a mantissa of a dividend of an input operand. The operation execution control unit determines a bit value at a specified position uniquely specified based on a radix of an operation execution process with respect to the partial remainder. The mantissa repetitive processing unit reduces the number of digit-recurrence processes by calculating a quotient and a remainder based on a determining result of the operation execution control unit. Here, the number of bits of the quotient is double of that of a quotient calculated once every the digit-recurrence process. The number of left-shift processes processed on the remainder is double of that of a remainder calculated once every the digit-recurrence process.

In order to achieve another aspect of the present invention, the present invention provides an information processing apparatus including: a floating point divider, which is a binary digit-recurrence floating point divider. The floating point divider includes: a mantissa repetitive processing unit; and an operation execution control unit. The mantissa repetitive processing unit calculates a quotient and a partial remainder by a digit-recurrence process for a mantissa of a dividend of an input operand. The operation execution control unit determines a bit value at a specified position uniquely specified based on a radix of an operation execution process with respect to the partial remainder. The mantissa repetitive processing unit reduces the number of digit-recurrence processes by calculating a quotient and a remainder based on a determining result of the operation execution control unit. Here, the number of bits of the quotient is double of that of a quotient calculated once every the digit-recurrence process. The number of left-shift processes processed on the remainder is double of that of a remainder calculated once every the digit-recurrence process.

In order to achieve still another aspect of the present invention, the present invention provides a floating point dividing method, which is a binary digit-recurrence floating point dividing method, including: calculating a quotient and a partial remainder by a digit-recurrence process for a mantissa of a dividend of an input operand; determining a bit value at a specified position uniquely specified based on a radix of an operation execution process with respect to the partial remainder; and reducing the number of digit-recurrence processes by calculating a quotient and a remainder, based on a determining result of the bit value at the specified position. Here, the number of bits of a quotient is double of that of a quotient calculated once every the digit-recurrence process. The number of left-shift processes processed on the remainder is double of that of a remainder calculated once every the digit-recurrence process.

### BRIEF DESCRIPTION OF THE DRAWINGS

The above and other objects, advantages and features of the present invention will be more apparent from the following description of certain preferred exemplary embodiments taken in conjunction with the accompanying drawings, in which:

FIG. 1 is a block diagram showing a configuration of a mantissa repetitive processing unit in a conventional binary digit-recurrence floating point divider based on the radix of 2;

FIG. 2 is a flowchart showing an operation of the mantissa repetitive processing unit in the binary digit-recurrence floating point divider shown in FIG. 1;

FIGS. 3A and 3B are block diagrams showing a configuration of a mantissa repetitive processing unit in a binary digit-recurrence floating point divider;

FIG. 4 is a block diagram showing a configuration of a typical binary digit-recurrence floating point divider;

FIG. 5 is a block diagram showing a configuration of a mantissa repetitive processing unit and its peripheral part in a floating point divider according to the first exemplary embodiment of the present invention;

FIG. 6 is a flowchart showing an operation of the mantissa repetitive processing unit and its peripheral part in the floating point divider according to the first exemplary embodiment of the present invention;

FIGS. 7A and 7B are block diagrams showing a configuration of a mantissa repetitive processing unit and its peripheral part in a floating point divider according to the second exemplary embodiment of the present invention; and

FIGS. 8A and 8B are flowcharts showing an operation of the mantissa repetitive processing unit and its peripheral part in the floating point divider according to the second exemplary embodiment of the present invention.

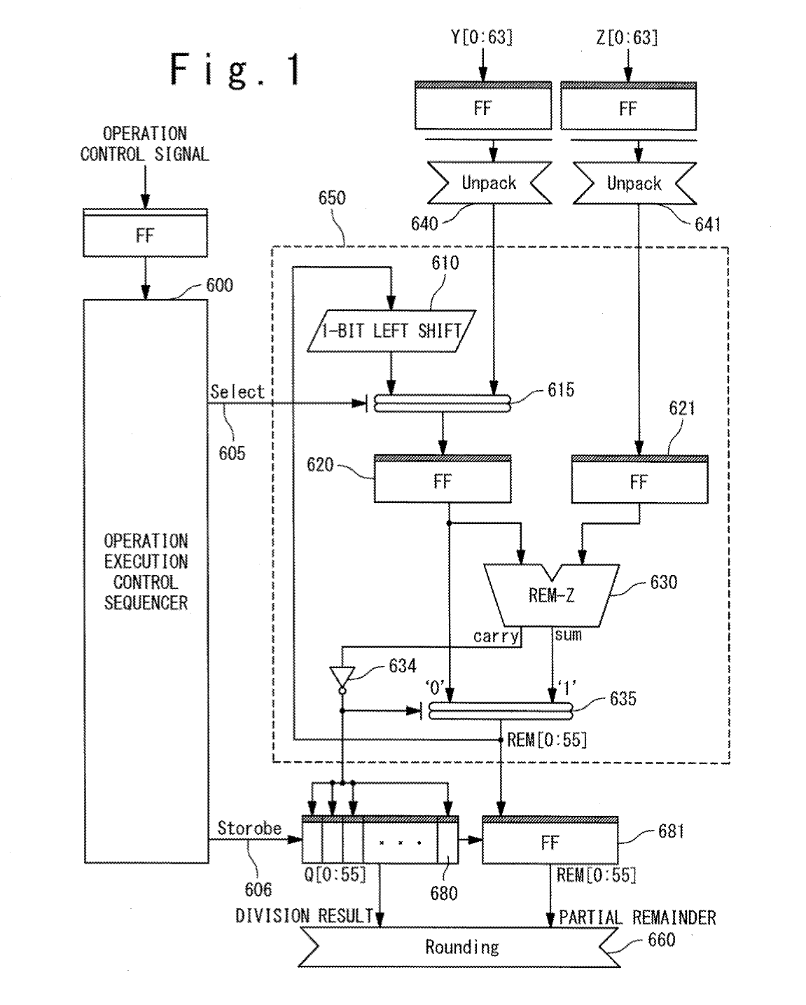

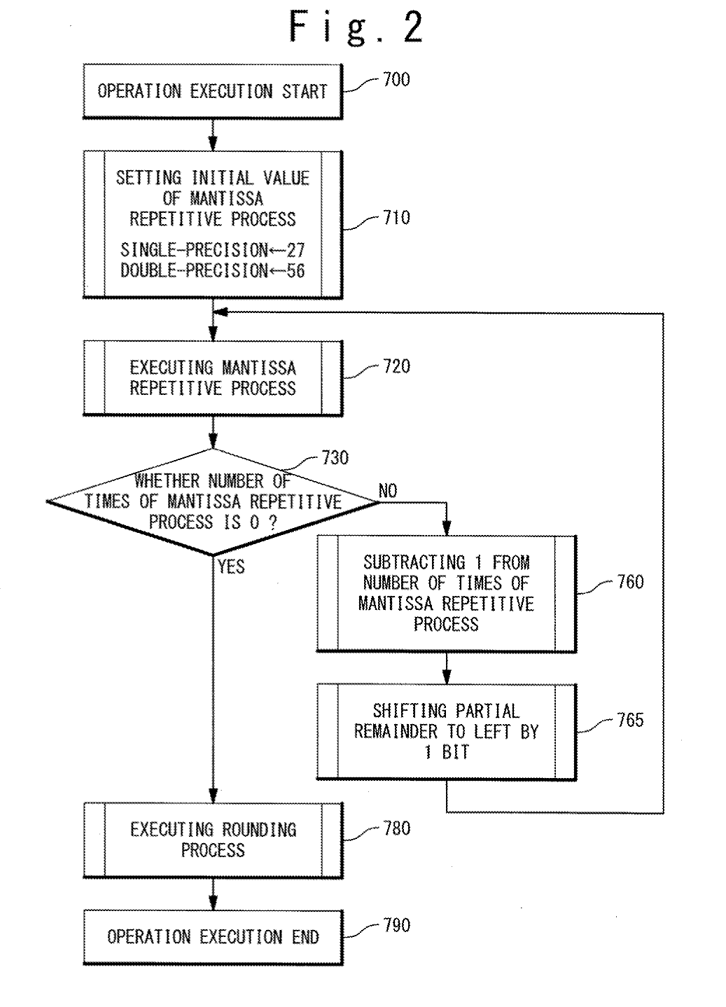

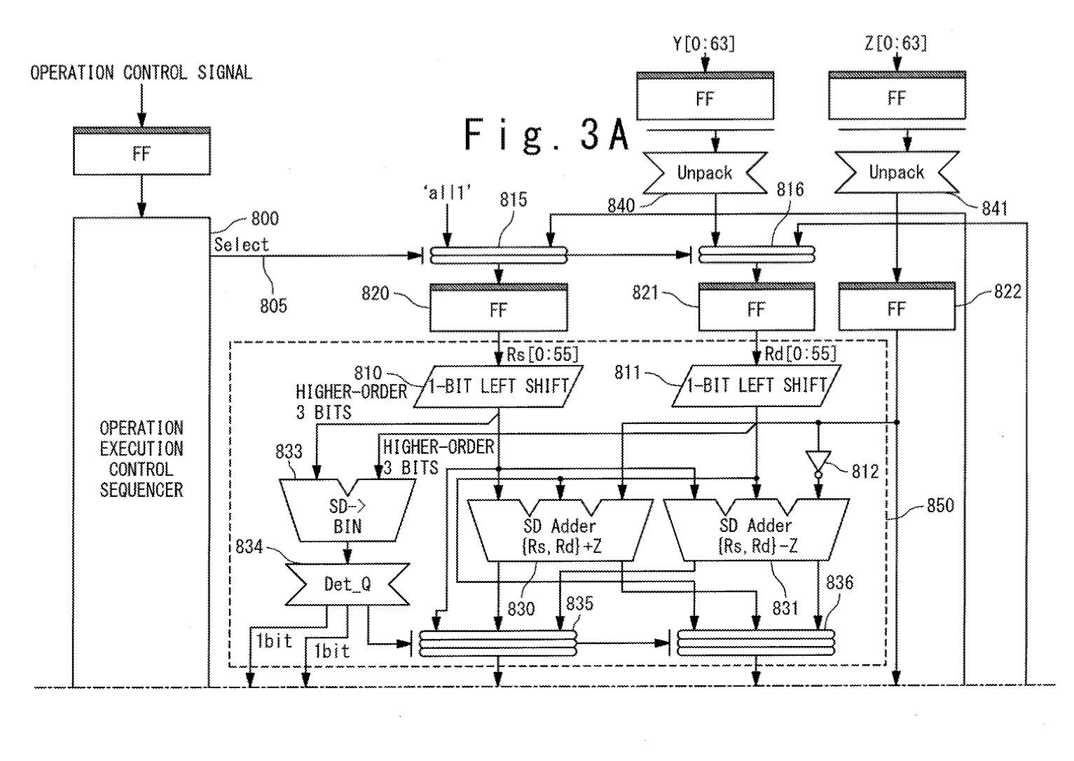

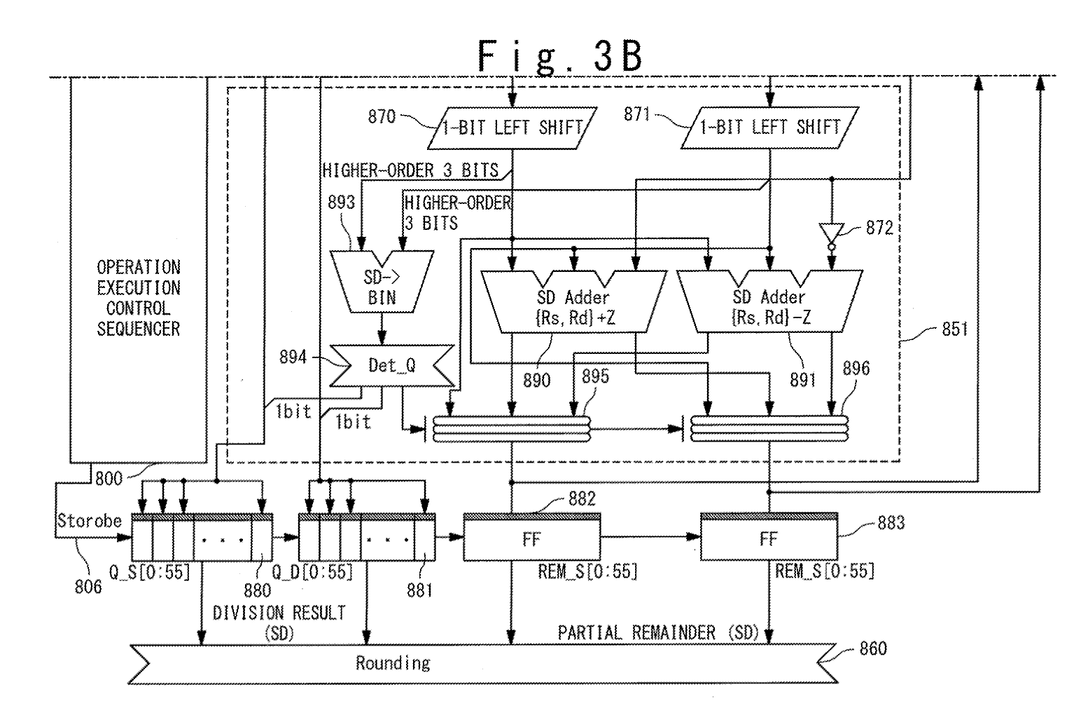

### DESCRIPTION OF THE PREFERRED EXEMPLARY EMBODIMENTS

Exemplary embodiments of a floating point divider and an information processing apparatus using the same according to the present invention will be described below with reference to the attached drawings.

### First Exemplary Embodiment

A floating point divider and an information processing apparatus using the same according to the first exemplary embodiment of the present invention will be described below with reference to the attached drawings.

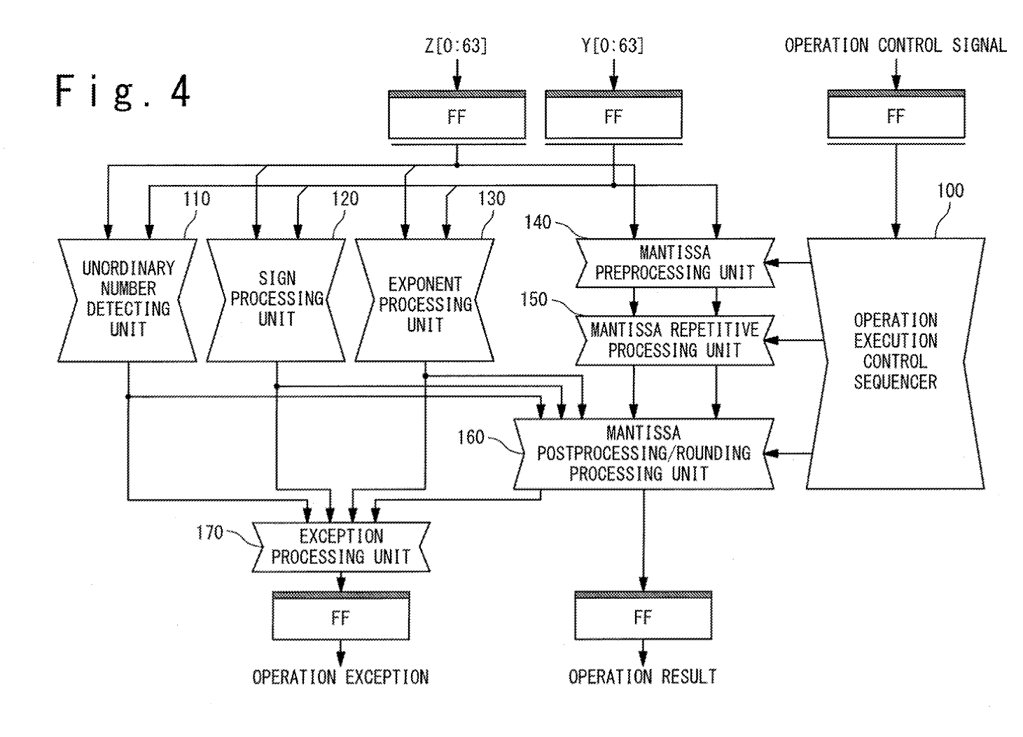

FIG. 4 is a block diagram showing a configuration of a typical binary digit-recurrence floating point divider. In this binary digit-recurrence floating point divider, two input floating point operands are received by two registers (FFs), respectively. After that, all bits or a part of bits of each of the two input floating point operands are supplied to an unordinary number detecting unit 110, a sign processing unit 120, an exponent processing unit 130 and a mantissa preprocessing unit 190. The each input floating point operand is separated into a sign, an exponent and a mantissa which are respectively defined based on bit positions. The sign, the exponent and the mantissa are supplied to the sign processing unit 120, the exponent processing unit 130 and the mantissa preprocessing unit 140, respectively. The mantissa preprocessing unit 140 executes a necessary preprocess on the mantissa and outputs the preprocess data to a mantissa repetitive processing unit 150 which executes a digit-recurrence process. The mantissa repetitive processing unit 150 executes the repetitive process on the preprocess data the predetermined times which are determined based on the desired operation precision, and outputs the repetitive process data to a mantissa postprocessing/rounding processing unit 160. The mantissa postprocessing/rounding processing unit 160 also receives the results of the unordinary number detecting unit 110, the sign processing unit 120 and the exponent processing unit 130 and outputs the final result of the floating point division. The mantissa postprocessing/rounding processing unit 160 also outputs the exponent carry data of the mantissa rounding process to an exception processing unit 170. The exception processing unit 170 also receives the outputs of the unordinary number detecting unit 110, the sign processing unit 120 and the exponent processing unit 130 and executes an operation exception detecting process. In addition, an operation execution control sequencer 100 is included, which controls operations of the respective units for performing the above-mentioned floating point division process. The operation execution control sequencer 100 supplies necessary control signals corresponding to respective execution sequences to the respective units.

The unordinary number detecting unit 110 detects whether or not each of the two input floating point operands is an unordinary number which cannot be expressed as an ordinary floating point number, such as a non-numeric value, an infinite number, a zero number or the like. If at least one of the two input floating point operands is such an unordinary number, the division result definitely becomes an unordinary number. Therefore, the unordinary number detecting unit 110 includes a combinational logic circuit for determining an unordinary number which should be outputted. The unordinary number detecting unit 110 outputs the result of the combinational logic circuit to the mantissa postprocessing/rounding processing unit 160 for changing the operation result output value into an unordinary number format.

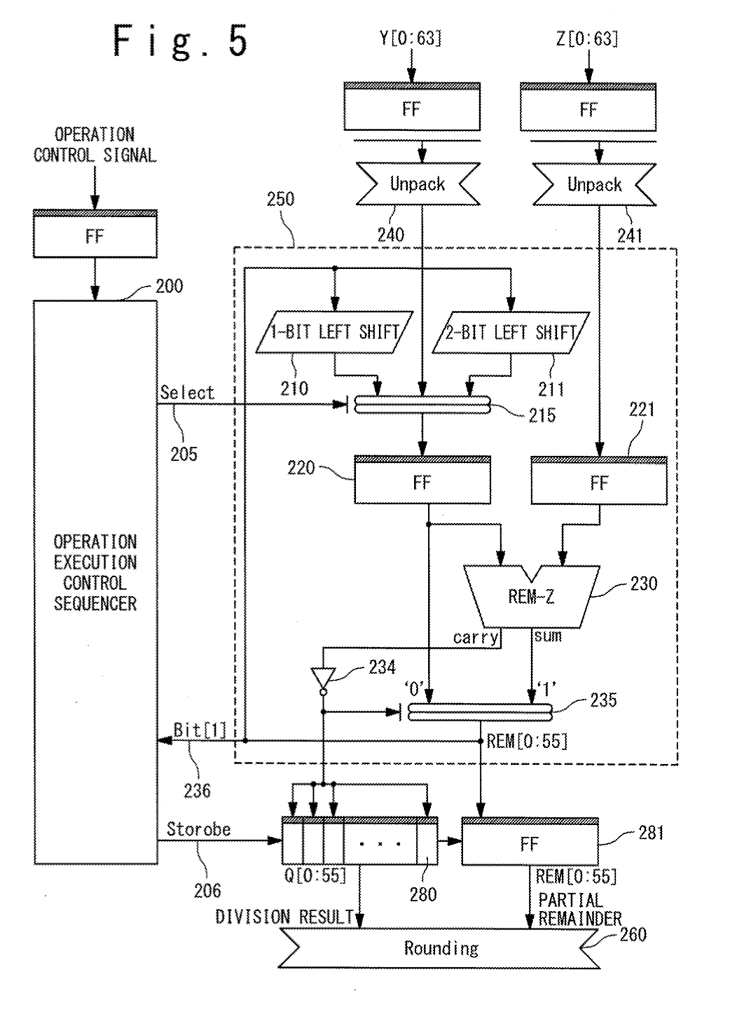

The sign processing unit 120 generates a sign bit of the operation result based on the sign of each of the two input floating point operands. Generally, this process is realized by an exclusive OR. The exponent processing unit 130 generates an exponent of the operation result based on the exponent of each of the two input floating point operands. Generally, this process is realized by a subtracter. However, in the case that an expression using a bias value is used for expressing a plus and minus of the exponent, this process is realized by an adder-subtracter with three inputs, considering this bias value. The mantissa preprocessing unit 140 and the mantissa repetitive processing unit 150 generate the quotient and the remainder of the operation result by executing the digit-recurrence process based on the mantissa of each of the two input floating point operands. The detail will be described later with reference to FIG. 5.

The mantissa postprocessing/rounding processing unit 160 receives the quotient and the remainder from the mantissa repetitive processing unit 150 and executes the mantissa generating process which rounds the quotient, to the effective bit number for the operation result. At this time, there is the case that the increment process is necessary for the exponent due to the carry of the mantissa. In this case, further using the sign from the sign processing unit 120 and the exponent from the exponent processing unit 130, the data format of the operation result is modified so as to be suitable for outputting.

Incidentally, the look ahead carry logic is relatively employed, in which, for performing the increment process for the exponent due to the carry of the mantissa, from the beginning, the exponent processing unit 130 generates two kinds of the exponents corresponding to the existence and nonexistence of the increment process, respectively, and one exponent is selected based on the result of the carry of the mantissa.

The exception processing unit 170 receives the outputs from the unordinary number detecting unit 110, the sign processing unit 120 and exponent processing unit 130 in addition to the rounding process result and the mantissa carry signal from the mantissa postprocessing/rounding processing unit 160. Then, the exception processing unit 170 detects the process exception. Generally, five kinds of detectable process exceptions exist, which are a floating point overflow exception, a floating point underflow exception, a zero division exception, an inexact exception and an invalid exception.

FIG. 5 is a block diagram showing a configuration of a mantissa repetitive processing unit and its peripheral part in the floating point divider according to the first exemplary embodiment of the present invention. The floating point divider according to the present exemplary embodiment is basically similar to the binary digit-recurrence floating point divider shown in FIG. 4. However, the floating point divider according to the present exemplary embodiment differs in the configuration of the mantissa repetitive processing unit and its peripheral part shown in FIG. 5 from the binary digit-recurrence floating point divider shown in FIG. 4. The floating point divider according to the present exemplary embodiment will be described with reference to FIG. 5.

Two floating point operands (Y: dividend, Z: divisor) supplied to this floating point divider are received by two registers (FFs), respectively. After that, the two floating point operands are supplied to data alignment units called Unpackers 240 and 241, respectively. In each of the Unpackers 240 and 241, only mantissa is extracted from the floating point operand and other process is executed, in which the sign bit(s) and the hidden bit(s) are supplemented and the decimal points of the single-precision floating point and the double-precision floating point are aligned. Generally, the process is called the mantissa preprocess. That is, in the floating point divider of the present exemplary embodiment, the mantissa preprocessing unit 140 in FIG. 4 is replaced by the Unpackers 240 and 241, or new function of the Unpackers 240 and 241 is added to the mantissa preprocessing unit 140 in FIG. 4.

The data outputted from the Unpacker 240 for the dividend Y is supplied to a first selector 215 controlled by using a selection control signal 205 outputted from an operation execution control sequencer 200. The first selector 215 selects the output data from the Unpacker 240 only at the first time of the mantissa digit-recurrence process after the operation execution starts. Here, in the floating point divider of the present exemplary embodiment, the operation execution control sequencer 100 in FIG. 4 is replaced by the operation execution control sequencer 200, or new function of the operation execution control sequencer 200 is added to the operation execution control sequencer 100 in FIG. 4. The data outputted from the first selector 215 is stored in a register 220. On the other hand, the data outputted from the Unpacker 241 for the divisor Z is supplied to and stored in a register 221. The register 221 for the divisor Z continues to store the value of the divisor Z during the operation execution.

Subtracter 230 executes the subtraction process on the data of the register 220 for the dividend Y and the data of the register 221 for the divisor Z. The carry bit outputted from the subtracter 230 is supplied to a second selector 235 as a selection control signal through an inverter 234. The second selector 235 selects and outputs one of the output of the subtracter 230 and the output of the register 220 for the dividend Y as a next partial remainder. The output of the second selector 235 becomes another input of the first selector 215 through a 1-bit left shifter 210. Simultaneously, the output of the second selector 235 becomes still another input of the first selector 215 through a 2-bit left shifter 211. In addition, the data 236 at the specified bit in the partial remainder, which is the output of the second selector 235, is outputted to the operation execution control sequencer 200. The operation execution control sequencer 200 generates a selection control signal 205 based on the specified bit data 236. The selection control signal 205 indicates whether or not the result of processing the partial remainder by the 2-bit left shifter 211 is select. The first selector 215 continues to select one of the output from the 1-bit left shifter 210 and the output from the 2-bit left shifter 211 at the second time or later of the mantissa digit-recurrence process after the operation execution starts based on the selection control signal 205 from operation execution control sequencer 200. The data outputted from the first selector 215 is stored in the register 220 as the partial remainder. The processing unit having the foregoing configuration is the mantissa repetitive processing unit 250. That is, in the floating point divider of the present exemplary embodiment, the mantissa repetitive processing unit 150 in FIG. 4 is replaced by the mantissa repetitive processing unit 250, or new function of the mantissa repetitive processing unit 250 is added to the mantissa repetitive processing unit 150 in FIG. 4.

Since the partial remainder stored in the register 220 holds “2×R(j)” caused by the 1-bit left shifter 210, the subtracter 230 can calculate “2×R(j)−D”. The carry bit outputted from the subtracter 230 corresponds to the sign bit of the result of “2×R(j)−D”. When the sign bit is “0”, it indicates “2×R(j)−D<0”. In this case, the result of inverting the carry bit by the inverter 234 is set to the quotient of the division. In addition, the second selector 235 selects “2×R(j)−D” outputted from the subtracter 230 as the partial remainder of the next time. On the other hand, when the sign bit is “1”, it indicates “2×R(j)−D<0”. In this case, the result of inverting the carry bit by the inverter 234 is set to the quotient of the division. In addition, the second selector 235 selects “2×R(j)” outputted from the register 220, which stores the partial remainder, as the partial remainder of the next time. As described above, the mantissa repetitive processing unit 250 realizes the execution procedure of the digit-recurrence division based on the radix of 2.

The quotient, in which the carry bit of the subtracter 230 is inverted by the inverter 234, is stored in a quotient register 280 every one bit in response to a strobe signal 206 outputted from the operation execution control sequencer 200. Here, in the quotient register 280, all bits are reset to “0” based on the control of the operation execution control sequencer 200 at the beginning of the operation execution. The output of the second selector 235 is stored in a remainder register 281 as a final remainder after all of the mantissa digit-recurrence process is completed in response to the strobe signal 206 outputted from the operation execution control sequencer 200. The outputs of the quotient register 280 and the remainder register 281 are supplied to a rounding processing unit 260. The rounding processing unit 260 executes the rounding process on the outputs. That is, in the floating point divider of the present exemplary embodiment, the rounding processing unit 160 in FIG. 4 is replaced by the rounding processing unit 260, or new function of the rounding processing unit 260 is added to the rounding processing unit 160 in FIG. 4.

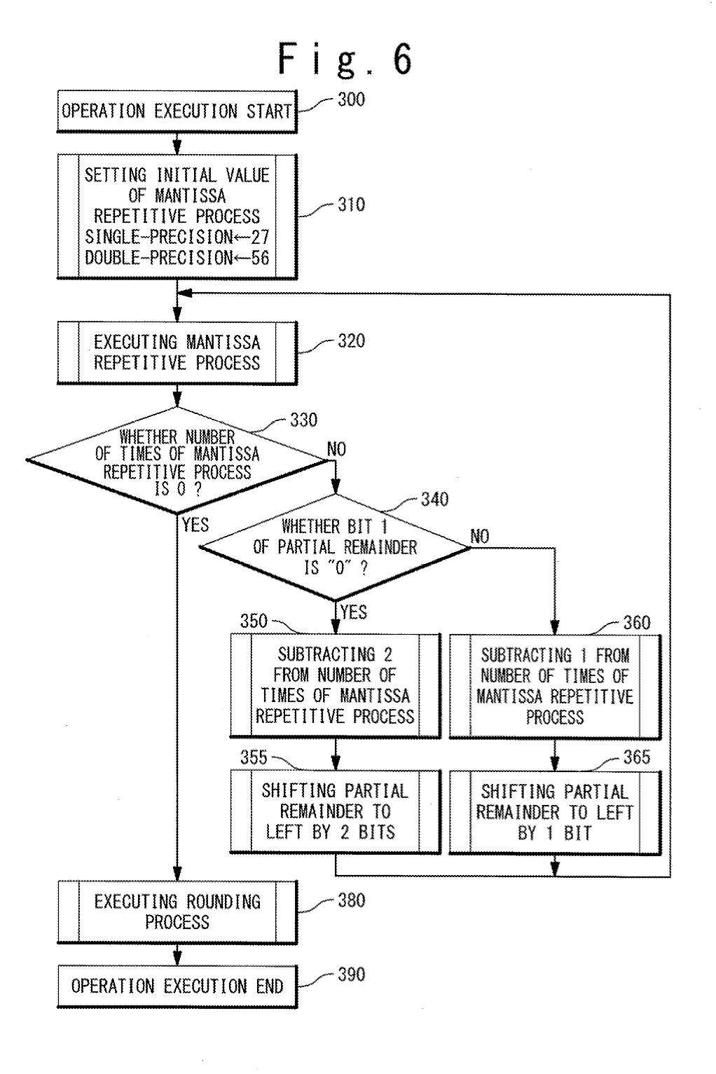

Next, an operation of the mantissa repetitive processing unit and its peripheral part in the floating point divider according to the first exemplary embodiment of the present invention shown in FIG. 5 will be described below. FIG. 6 is a flowchart showing an operation of the mantissa repetitive processing unit and its peripheral part in the floating point divider according to the first exemplary embodiment of the present invention. The operation shown here is implemented as hardware in the operation execution control sequencer 200 in FIG. 5, for example. Each operation result of each step in the flowchart is outputted as a control signal for the mantissa repetitive processing unit 250 and the mantissa postprocessing/rounding processing unit 260.

When the operation execution starts (STEP 300), the initial value of the number of times of the mantissa digit-recurrence process is set first (STEP 310). Generally, the initial value at this time is 27 times when an operation data is a single-precision floating point data (32 bits) and 56 times when an operation data is a double-precision floating point data (64 bits). Next, the mantissa repetitive process is executed (STEP 320). This process is to obtain a quotient of 1 bit and a partial remainder by using the mantissa digit-recurrence process. Subsequently, after the end of the mantissa repetitive process (STEP 320), it is determined whether or not the number of times of the mantissa digit-recurrence process is 0 (STEP 330). If the number of times of the mantissa digit-recurrence process is 0 (STEP 330: Yes), the rounding process is executed (STEP 380) and the operation execution ends (STEP 390).

On the other hand, if the number of times of the mantissa digit-recurrence process is not 0 (STEP 330: No), it is determined whether or not the second bit from the MSB (Most Significant Bit) in the partial remainder obtained at the mantissa repetitive process (STEP 320) is the bit value of 0 (STEP 340). Here, if the MSB is the bit 0, the second bit is the bit 1. Specifically, the specified bit data 236 indicating the second bit from the MSB in the partial remainder is received, and it is determined whether or not the specified bit data 236 is the bit value of 0. If the specified bit data 236 is not the bit value of 0 (STEP 340: No), similar to the ordinary digit-recurrence floating point divider, “1” is subtracted from the number of times of the mantissa repetitive process (STEP 360), the partial remainder is shifted to the left by 1 bit (the partial remainder is doubled: the selection control signal 205) (STEP 365) and the operation returns to the mantissa repetitive process (STEP 320).

On the other hand, if the specified bit data 236 is the bit value of 0 (STEP 340: Yes), it is previously found that the quotient of 1 bit becomes inevitably the bit value of 0 in the next digit-recurrence process. Then, “2” is subtracted from the number of times of the mantissa repetitive process (STEP 350), the partial remainder is shifted to the left by 2 bits (the partial remainder is quadrupled: the selection control signal 205) (STEP 355) and the operation returns to the mantissa repetitive process (STEP 320). In this case, the next operation result is stored in the place shifted by 2 bits based on the next strobe signal 206 when stored in the quotient register 280.

This leads to once reduction of the digit-recurrence process in the next time. Such situation is not limited once in the digit-recurrence processes repeated 56 times for the double-precision floating point data. There is a possibility that such situation arise plural times depending on the partial remainder of the digit-recurrence processes. Therefore, the operation TAT can be reduced much for the number of the situations. At that time, the operation result can be obtained within the number of times of the digit-recurrence process which is much less than the number of times of the digit-recurrence process which should be originally executed. Therefore, the electric power consumption necessary to obtain the operation result can be definitely reduced.

Further, as clearly shown in FIG. 5 and its related explanation, the elements added to the conventional configuration is only the logic that the specified bit data 236 of the partial remainder is supplied to the operation execution control sequencer 200 and the selection control signal 205 is generated based on the data. Here, the selection control signal 205 indicates whether or not the result of the 2-bit left shifter 211 for the partial remainder is made to be the partial remainder for the next digit-recurrence process. In the flowchart of FIG. 6, this corresponds to: the STEP 340 of determining whether or not the second bit from the MSB in the partial remainder is the bit value of 0 (the MSB is the bit 0, the second bit is the bit 1); the STEP 350 of subtracting “2” from the number of times of the mantissa repetitive process if the specified bit data 236 is the bit value of 0; and the STEP 355 of shifting the partial remainder to the left by 2 bits (the partial remainder is quadrupled). The influences of these added elements and added process flows on the increase of the hardware amount and the delay time of the critical path is small, and this causes less design difficulty.

As described above, the present exemplary embodiment can achieve effects as shown below.

The first effect is as follows. In the binary digit-recurrence floating point divider, essentially, the number of times of the digit-recurrence process is uniquely determined based on the radix and the operation precision. On the other hand, the exemplary embodiment of the present invention, the number of times of the digit-recurrence process can be reduced even depending on values of operation input operands. As a result, the division operation TAT can be reduced and the operation performance can be improved.

The second effect is that the electric power consumption for single operation can be decreased because the useless digit-recurrence process is not executed in the division operation.

The third effect is as follows. The amount of the added hardware is small and the influence on the critical path delay is suppressed. Therefore, to obtain the high operation performance, without using the Domino circuit or employing the custom designing method, the circuit/layout design can be employed using the automated design tool in a conventional manner to save labor.

### Second Exemplary Embodiment

A floating point divider and an information processing apparatus using the same according to the first exemplary embodiment of the present invention will be described below with reference to the attached drawings.

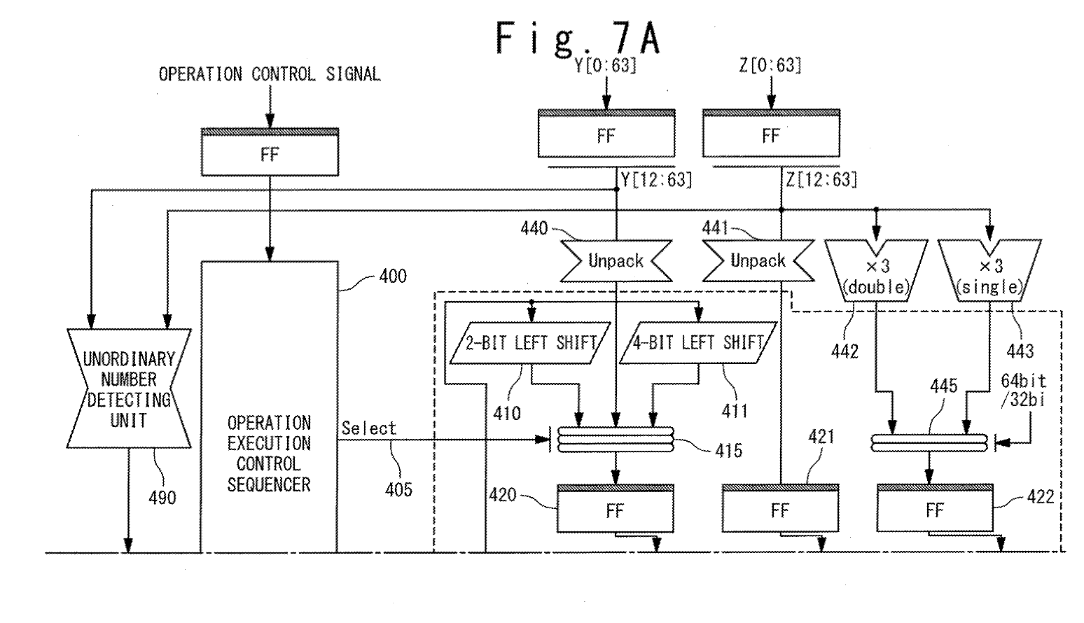

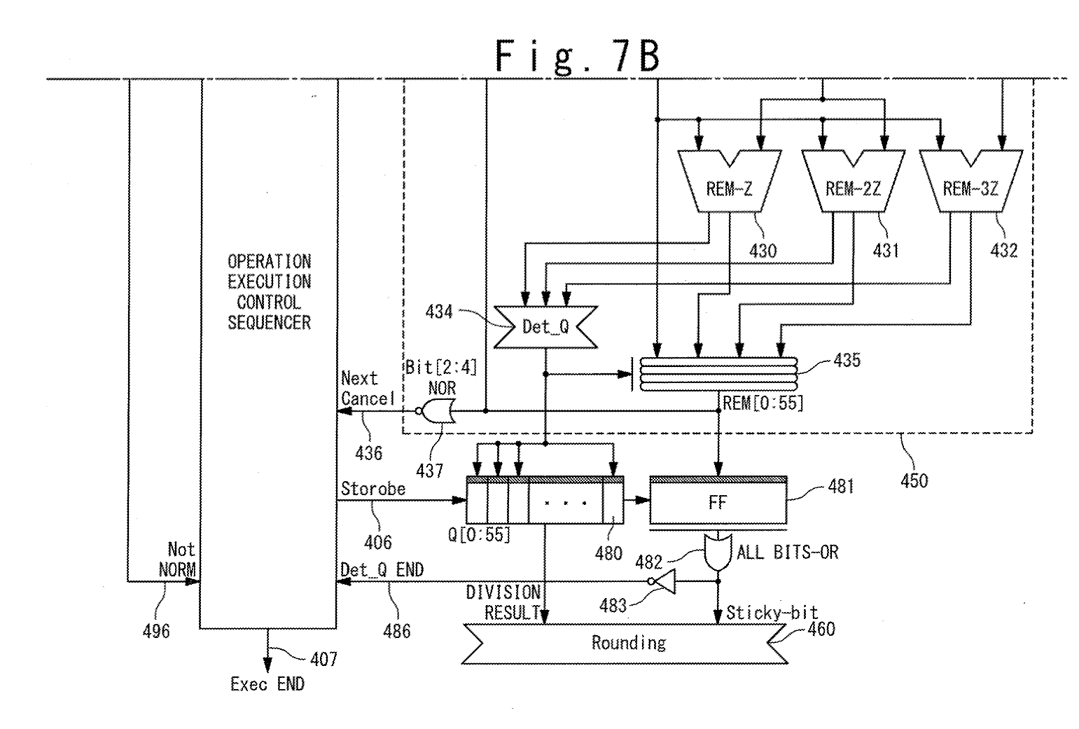

FIGS. 7A and 7B are block diagrams showing a configuration of a mantissa repetitive processing unit and its peripheral part in the floating point divider according to the second exemplary embodiment of the present invention. In the present exemplary embodiment, the configuration of the floating point divider is basically the same as that in the first exemplary embodiment. However, the configuration is different from that in the first exemplary embodiment at a point that the configuration shown in FIG. 5 is replaced by the configuration shown in FIGS. 7A and 7B. That is, the radix is changed to 4 (four) and the determination logic is further added for reducing the number of times of the digit-recurrence process. The detail will be explained below.

Two floating point operands (Y: dividend, Z: divisor) supplied to this floating point divider are received by two registers (FFs), respectively. After that, the two floating point operands are supplied to Unpackers 440 and 441, respectively. In addition, the floating point operand (divisor Z) is also supplied to both of an adder 442 and an adder 443. The processes of the Unpackers 440 and 441 are the same as the Unpackers 240 and 241 shown in FIG. 5, respectively.

The data outputted from the Unpacker 440 for the dividend Y is supplied to a first selector 415 controlled by using a selection control signal 405 outputted from an operation execution control sequencer 400. The first selector 415 selects the output data from the Unpacker 440 only at the first time of the mantissa digit-recurrence process after the operation execution starts. The data outputted from the first selector 415 is stored in a register 420. On the other hand, the data outputted from the Unpacker 441 for the divisor Z is supplied to and stored in a divisor register 421. Further, as mentioned above, the floating point operand (divisor Z) is supplied to both of the adder 442 and the adder 443. The adder 442 triples the divisor for the double-precision operation and outputs the result to a selector 445. The adder 443 triples the divisor for the single-precision operation and outputs the result to the selector 445. The selector 445 selects one of the outputs of the adders 442 and 443 based on whether the precision of the execution operation is the double-precision or the single precision. The data outputted from the selector 445 is stored in a divisor tripling register 422. These divisor register 421 and divisor tripling register 422 continue to store the values of the divisor and the tripled divisor, respectively, during the operation execution.

Subtracters 430, 431 and 432 execute the subtraction processes on the data of the register 420 for the dividend, the data of the register 421 for the divisor and the data of the register 422 for the tripled divisor. The carry bits outputted from the subtracters 430, 431 and 432 are supplied to a second selector 435 as a selection control signal through a quotient determination logic unit 434. The second selector 435 selects and outputs one of the three outputs of the subtracters 430, 431 and 432 and the outputs of the register 420 for the dividend as a next partial remainder. The output of the second selector 435 becomes another input of the first selector 415 through a 2-bit left shifter 410. Simultaneously, the output of the second selector 435 becomes still another input of the first selector 415 through a 4-bit left shifter 411. In addition, a detection logic unit 437 receives the partial remainder outputted from the second selector 435 and outputs an output signal 436 to the operation execution control sequencer 400. Here, the output signal 436 indicates a detection logic whether or not all of the 3 bits, which are from the second bit to fourth bit (counting from the MSB) of the partial remainder outputted from the second selector 435, are the bit values of 0. The operation execution control sequencer 400 generates the selection control signal 405 based on the output signal 436. The selection control signal 405 indicates whether the output of the 2-bit left shifter 410 or the output of the 4-bit left shifter 411 is the partial remainder of the next digit-recurrence process. The first selector 415 continues to select one of the output from the 2-bit left shifter 410 and the output from the 4-bit left shifter 411 at the second time or later of the mantissa digit-recurrence process after the operation execution starts based on the selection control signal 405 from operation execution control sequencer 400. The data outputted from the first selector 415 is stored in the register 420 as the partial remainder.

Since the partial remainder stored in the register 420 holds “4×R(j)” caused by the 2-bit left shifter 910, the first subtracter 430 can calculate “4×R(j)−D”. The carry bit outputted from the first subtracter 430 corresponds to the sign bit of the result of “4×R(j)−D”. When the sign bit is the bit value of 0, it indicates “4×R(j)−D≧0”. Similarly, the second subtracter 431 can calculate “4×R(j)−2×D”. When the carry bit is the bit value of 0, it indicates “4×R(j)-2×D 0”. Similarly, the third subtracter 432 can calculate “4×R(j)−3×D”. When the carry bit is the bit values of 0, it indicates “4×R(j)−3×D≧0”. The quotient determination logic unit 434 can determine one of “0”, “1”, “2” and “3” as the quotient of 2 bits based on the carry signals from the subtracters 430, 431 and 432. That is, if all of the carry signals are the bit values of 1, the quotient is “0”. If the carry signal of the first subtracter 430 is the bit value of 0 and the others are the bit values of “1”, the quotient is “1”. If the carry signals of the first subtracter 430 and the second subtracter 431 are the bit values of “0” and the carry signal of the third subtracter 432 is the bit value of “1”, the quotient is “2”. If the three carry signals of the three subtracters 930, 431 and 432 are the bit values of “0”, the quotient is “3”. As shown above, the quotient of 2 bits in the digit-recurrence process based on the radix of 4 can be obtained. In addition, corresponding to the value of the quotient, the second selector 435 selects one of “4×R(j)” which is the output of the register 420 storing this time partial remainder, “4×R(j)−D” which is the output of the first subtracter 430, “4×R(j)−2×D” which is the output of the second subtracter 431 and “4×R(j)−3×D” which is the output of the third subtracter 432 as the partial remainder for the next time digit-recurrence process.

The quotient outputted from the quotient determination logic unit 434 is stored in a quotient register 480 every two bit in response to a strobe signal 406 outputted from the operation execution control sequencer 400. Here, in the quotient register 480, all bits are reset to the bit values of “0” based on the control of the operation execution control sequencer 400 at the beginning of the operation execution. The output of the second selector 435 is stored in a remainder register 481 in response to the strobe signal 406 outputted from the operation execution control sequencer 400. The configuration above is the mantissa preprocessing unit (440, 441, 942 and 443) and the mantissa repetitive processing unit 450 of the digit-recurrence divider based on the radix of 4.

The floating point divider in the present exemplary embodiment firstly includes the detection logic unit 437 as an additional configuration element. The detection logic unit 437 detects whether or not all of the 3 bits, which are from the second bit to fourth bit (from the MSB) of the partial remainder outputted from the second selector 435, are the bit values of 0. The configuration example shown in FIGS. 7A and 7B, the detection logic unit 437 can be realized using the NOR (Not-OR) logic with three inputs. The output signal 436 from the detection logic unit 437 is supplied to the operation execution control sequencer 400. Based on the output signal 436, the operation execution control sequencer 400 determines, as the selection control signal 405 for the first selector 415, whether the output of the 2-bit left shifter 410 or the output of the 4-bit left shifter 411 is the partial remainder of the next time digit-recurrence process. Usually, the output of the 2-bit left shifter 410 is selected. That is, if all of the 3 bits from the second bit to fourth bit (from the MSB) of the partial remainder are the bit values of 0, all of the 3 bits from the MST of the partial remainder are the bit value of 0 after the 2-bit left shift process. At that time, considering the data stored in the divisor register 421 and the tripled divisor register 422, it is easy to understand that all carry signals of the three subtracters 430, 431 and 432 at the next time digit-recurrence process indicate the bit values of 1 and the quotient at the next time digit-recurrence process becomes 0 (2 bits). In this case, as the selection control signal for the first selector 415, the signal selecting the output of the 4-bit left shifter 411 is outputted to skip the next time digit-recurrence process.

The floating point divider in the present exemplary embodiment further includes detection logic as another additional configuration element. The detection logic detects whether or not all of the bits of the remainder register 481 are the bit values of 0. Usually, such logic is used as a sticky-bit for the mantissa rounding process at the rounding processing unit 460 which executes the OR logic of all bits of the reminder register after the digit-recurrence process is ended and the final remainder is stored in the remainder register. However, in the present invention, the detection logic operates at all timings during all digit-recurrence process execution. The detection whether or not all of the bits are the bit values of 0 is realized using the NOR (Not-OR) logic. Therefore, the detection logic, which is the all bits 0 detection logic for the remainder register 481, can be configured using an OR unit 482 as a sticky-bit generating logic and an inverter 483 for inverting its output. A detection signal 486, which is the output of the inverter 483, is supplied to the operation execution control sequencer 400. If all of the bits of the remainder register 481 are the bit values of 0 during the digit-recurrence process execution, it means that the division gives the exact answer at that time. In this case, the operation execution control sequencer 400 cancels execution of all subsequent digit-recurrence processes and transfers to the mantissa postprocessing and rounding processing in the process sequence to achieve the reduction of the operation TAT. Further, this configuration may be incorporated to the configuration shown in FIG. 5 (the first exemplary embodiment). In this case, the STEP 570 described later is incorporated to the operation.

The floating point divider in the present exemplary embodiment further includes an unordinary number detecting unit 490 as another additional configuration element. The unordinary number detecting unit 490 detects whether or not each of the two floating point operands (Y: dividend, Z: divisor) supplied to the floating point divider is an unordinary number. An unordinary number detection signal 496 outputted from the unordinary number detecting unit 490 is supplied to the operation execution control sequencer 400. If at least one of the two floating point operands is detected as an unordinary number, the division result definitely becomes an unordinary number. In this case, it is not necessary to execute the mantissa digit-recurrence process itself. Therefore, even in this case, the operation execution control sequencer 400 cancels execution of all subsequent digit-recurrence processes and transfers to the mantissa postprocessing and rounding processing in the process sequence to achieve the reduction of the operation TAT.

Incidentally, in the reduction of the operation TAT in the present exemplary embodiment, the operation TAT is not a fixed time period but is varied depending on values of supplied operand data. Consequently, at the timing when the mantissa digit-recurrence process ends and the process sequence transfers to the mantissa postprocessing and rounding processing, the operation execution control sequencer 400 outputs an operation execution ending advance notice signal 407 to a command issuing control logic (control circuit outside the floating point divider or the like). If the operation execution ending advance notice signal 407 is outputted, the rounding process ends inevitably after the fixed time period passes from that time and the operation result is finally determined. Therefore, the process of issuing a sequence command can be preformed. Further, this configuration, in which at the timing when the mantissa digit-recurrence process ends and the process sequence transfers to the mantissa postprocessing and rounding processing, the operation execution ending advance notice signal is outputted to the command issuing control logic, may be incorporated to the configuration shown in FIG. 5 (the first exemplary embodiment).

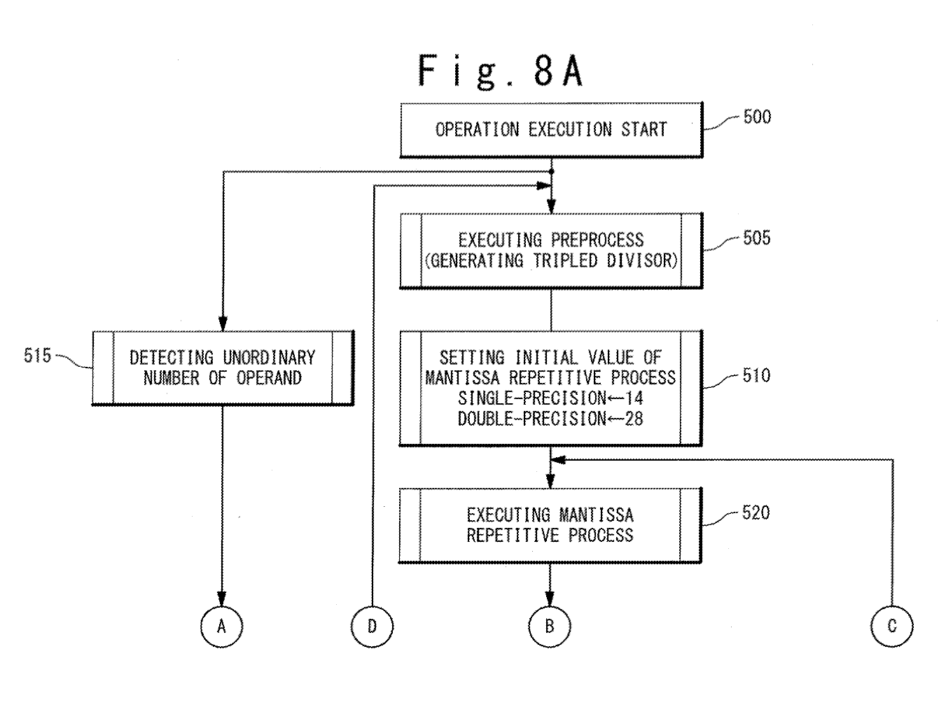

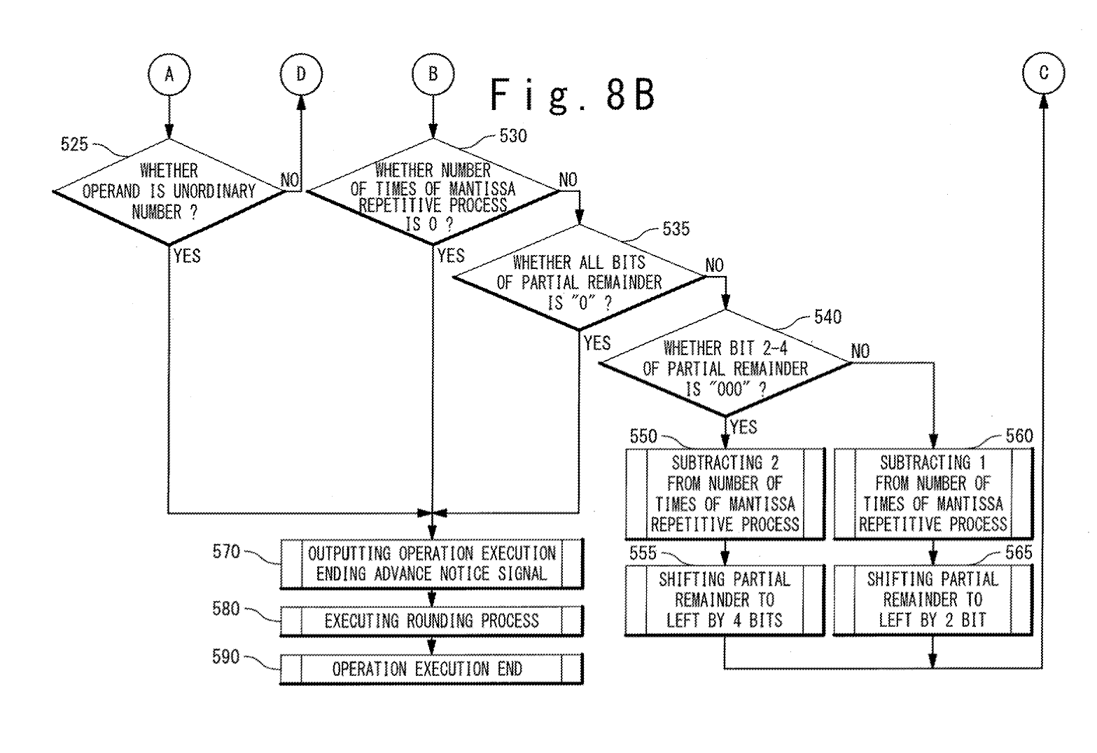

Next, an operation of the mantissa repetitive processing unit and its peripheral part in the floating point divider according to the second exemplary embodiment of the present invention shown in FIGS. 7A and 7B will be described below. FIGS. 8A and 8B is a flowchart showing an operation of the mantissa repetitive processing unit and its peripheral part in the floating point divider according to the second exemplary embodiment of the present invention. The operation shown here is implemented as hardware in the operation execution control sequencer 400 in FIGS. 7A and 7B, for example. Each operation result of each step in the flowchart is outputted as a control signal for the mantissa repetitive processing unit 450 and the mantissa postprocessing/rounding processing unit 460.

When the operation execution starts (STEP 500), the floating point operand (divisor Z) is tripled to generate the tripled divisor for the double-precision operation and the tripled divisor for the single-precision operation first. Then, one of the tripled divisor for the double-precision operation and the tripled divisor for the single-precision operation is selected and stored based on whether the execution operation is the double-precision or the single-precision (STEP 505). Next, the initial value of the number of times of the mantissa digit-recurrence process is set (STEP 510). Generally, due to the radix of 4, the initial value at this time is 14 times when an operation data is a single-precision floating point data (32 bits) and 28 times when an operation data is a double-precision floating point data (64 bits). Next, the mantissa repetitive process is executed (STEP 520). This process is to obtain a quotient of 2 bits and a partial remainder by using the mantissa digit-recurrence process. Subsequently, after the end of the mantissa repetitive process (STEP 520), it is determined whether or not the number of times of the mantissa digit-recurrence process is 0 (zero) (STEP 330). If the number of times of the mantissa digit-recurrence process is 0 (STEP 530: Yes), the operation execution ending advance notice signal is outputted (STEP 570), the rounding process is executed (STEP 580) and the operation execution ends (STEP 590).

On the other hand, if the number of times of the mantissa digit-recurrence process is not 0 (STEP 530: No), it is determined Whether or not all bits of the partial remainder are the bit values of 0 (STEP 535). If all bits of the partial remainder are the bit values of 0 (STEP 535: Yes), the operation execution ending advance notice signal is outputted (STEP 570), the rounding process is executed (STEP 580) and the operation execution ends (STEP 590).

Incidentally, at the start of the operation execution (STEP 500), the detection is executed whether or not each of the two input floating point operands is an unordinary number (STEP 515). Then, it is determined whether or not at least one of the two input floating point operands is such an unordinary number (STEP 525). If at least one of the two input floating point operands is an unordinary number (STEP 525: Yes), the operation execution ending advance notice signal is outputted (STEP 570), the rounding process is executed (STEP 580) and the operation execution ends (STEP 590). If both of the two input floating point operands are not unordinary numbers (STEP 525: No), the operation procedure returns to the STEP 505 and the operation is executed.

If all bits of the partial remainder are not the bit values of 0 (STEP 535: No), it is determined whether or not the three bits of the third bit, the fourth bit and fifth bit from the MSB (the bit 2 to the bit 4 if the MSB is the bit 0) in the partial remainder obtained at the mantissa repetitive process (STEP 520) are the bit values of 0 (STEP 540). Specifically, the output signal 436 indicating the bit values of the three bits of the third bit, the fourth bit and fifth bit from the MSB in the partial remainder is received, and it is determined whether or not the output signal 436 is the bit value of 0. If all of the three bits are not the bit values of 0 (the output signal 436 is not the bit value of 0) (STEP 540: No), similar to the ordinary digit-recurrence divider based on the radix of 4, “1” is subtracted from the number of times of the mantissa repetitive process (STEP 560), the partial remainder is shifted to the left by 2 bits (the partial remainder is quadrupled: the selection control signal 405) (STEP 565) and the operation returns to the mantissa repetitive process (STEP 520).

On the other hand, if all of the three bits are the bit values of 0 (the output signal 436 is the bit value of 0) (STEP 590: Yes), it is previously found that the quotient of 2 bits becomes inevitably 00 in the next digit-recurrence process. Then, “2” is subtracted from the number of times of the mantissa repetitive process (STEP 550), the partial remainder is shifted to the left by 4 bits (the partial remainder is multiplied by sixteen: the selection control signal 405) (STEP 555) and the operation returns to the mantissa repetitive process (STEP 420).

This leads to once reduction of the digit-recurrence process in the next time. Such situation is not limited once in the digit-recurrence process which is repeated 28 times for the double-precision floating point data. There is a possibility that such situation arise plural times depending on the partial remainder of the digit-recurrence process. Therefore, the operation TAT can be reduced much for the number of the situations. At that time, the operation result can be obtained within the number of times of the digit-recurrence process which is much less than the number of times of the digit-recurrence process which should be originally executed. Therefore, the electric power consumption necessary to obtain the operation result can be definitely reduced.

As mentioned above, in the present invention, using the radix of 4, in addition to the reduction of the operation TAT based on the reduction of the number of times of the digit-recurrence process, other mechanisms for the reduction of the operation TAT is further incorporated. One of the mechanisms is that the digit-recurrence process is stopped when the state of the dividend being exactly divided by the divisor is detected during the digit-recurrence process. The other of the mechanisms is that the digit-recurrence process is stopped when the state of the input operand being an unordinary number is detected. Further, the mechanism is incorporated that the operation execution ending advance notice single is outputted to the outside command issuing control logic. This leads to the subsequence command issue control being easy even though the operation TAT is varied based on the input operands.

Incidentally, the radix of 4 is employed in the present exemplary embodiment. However, it may be possible to achieve the present invention employing the power-of-two radix larger than 4 by using the configuration similar to the present exemplary embodiment. In addition, if the increase of the critical path delay time (decrease of operation frequency) and the increase of the hardware amount can be allowable, cascade-connecting and implementing of a plurality of the mantissa digit-recurrence processing units according to the present invention can make the operation TAT decrease much lower.

The present invention can reduce the operation TAT to improve the performance and decrease the electric power consumption while avoiding the hardware significant increase, the critical path delay increase and design difficulty increase.

The floating point divider according to the present invention is applied to an information processing apparatus such as a workstation, a personal computer, a cell-phone and the like. For example, the floating point divider according to the present invention can be realized as a semiconductor integrated circuit mounted on the information processing apparatus.

Although the present invention has been described above in connection with several exemplary embodiments thereof, it would be apparent to those skilled in the art that those exemplary embodiments are provided solely for illustrating the present invention, and should not be relied upon to construe the appended claims in a limiting sense.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims. The techniques in one embodiment can be applied to the other embodiment if the technical inconsistency occurs.

What is claimed is:

1. A floating point divider, which is a binary digit-recurrence floating point divider, comprising:
a mantissa repetitive processing unit configured to calculate a quotient and a partial remainder by a digit-recurrence process for a mantissa of a dividend of an input operand; and
an operation execution control unit configured to determine a bit value at a specified position uniquely specified based on a radix of an operation execution process with respect to said partial remainder,
wherein said mantissa repetitive processing unit reduces the number of digit-recurrence processes by calculating a quotient of which the number of bits is double of that of a quotient calculated once every said digit-recurrence process and a remainder on which the number of left-shift processes is double of that of a remainder calculated once every said digit-recurrence process, based on a determining result of said operation execution control unit.

2. The floating point divider according to claim 1, wherein said operation execution control unit outputs an advance notice signal to the outside at a timing when said digit-recurrence process ends and a rounding process starts,
wherein said advance notice signal indicates that an operation ends after a fixed time period passes.

3. The floating point divider according to claim 2, further comprising:
a determining unit configured to determine whether or not all bits of said partial remainder are bit values of 0,
wherein said operation execution control unit stops said digit-recurrence process and starts said rounding process when said all bits of said partial remainder are bit values of 0, based on a determining result of said determining unit.

4. The floating point divider according to claim 2, further comprising:
an unordinary number detecting unit configured to detect whether or not said input operand is an unordinary number,
wherein said operation execution control unit stops said digit-recurrence process and starts said rounding process when said input operand is detected as an unordinary number, based on a detecting result of said unordinary number detecting unit.

5. The floating point divider according to claim 1, wherein said mantissa repetitive processing unit includes:
a 1-bit left shifter configured to shift said partial remainder to the left by 1 bit,
a 2-bit left shifter configured to shift said partial remainder to the left by 2 bits,
a first selector configured to select one of said mantissa of said dividend, said partial remainder outputted from said 1-bit left shifter and said partial remainder outputted from said 2-bit left shifter as a first partial remainder, based on a selection signal,
a subtracter configured to execute a subtraction process based on said first partial remainder and a divisor of said input operand and output a carry bit and a subtraction result, and
a second selector configured to output one of said first partial remainder and said subtraction result as said partial remainder newly based on said carry bit to said 1-bit left shifter, said 2-bit left shifter and said operation execution control unit,
wherein said mantissa repetitive processing unit outputs said bit value at said specified position to said operation execution control unit based on said partial remainder, and
wherein said operation execution control unit generates said selection signal based on said bit value of said specified position and output said selection signal to said first selector.

6. The floating point divider according to claim 1, wherein said mantissa repetitive processing unit includes:
a 2-bit left shifter configured to shift said partial remainder to the left by 2 bits,
a 4-bit left shifter configured to shift said partial remainder to the left by 4 bits,
a first selector configured to select one of said mantissa of said dividend, said partial remainder outputted from said 2-bit left shifter and said partial remainder outputted from said 4-bit left shifter as a first partial remainder, based on a selection signal,
a first subtracter configured to execute a subtraction process based on said first partial remainder and a divisor of said input operand and output a first carry bit and a first subtraction result,
a second subtracter configured to execute a subtraction process based on said first partial remainder and a value that said divisor of said input operand is doubled and output a second carry bit and a second subtraction result,
a third subtracter configured to execute a subtraction process based on said first partial remainder and a value that said divisor of said input operand is tripled and output a third carry bit and a third subtraction result, and
a second selector configured to output one of said first partial remainder, said first subtraction result, said second subtraction result and said third subtraction result as said partial remainder newly based on said first carry bit, said second carry bit and said third carry bit to said 2-bit left shifter, said 4-bit left shifter and said operation execution control unit,
wherein said mantissa repetitive processing unit outputs said bit value at said specified position to said operation execution control unit based on said partial remainder, and
wherein said operation execution control unit generates said selection signal based on said bit value of said specified position and output said selection signal to said first selector.

7. An information processing apparatus comprising:
a floating point divider, which is a binary digit-recurrence floating point divider,
wherein said floating point divider includes:
a mantissa repetitive processing unit configured to calculate a quotient and a partial remainder by a digit-recurrence process for a mantissa of a dividend of an input operand, and
an operation execution control unit configured to determine a bit value at a specified position uniquely specified based on a radix of an operation execution process with respect to said partial remainder,
wherein said mantissa repetitive processing unit reduces the number of digit-recurrence processes by calculating a quotient of which the number of bits is double of that of a quotient calculated once every said digit-recurrence process and a remainder on which the number of left-shift processes is double of that of a remainder calculated once every said digit-recurrence process, based on a determining result of said operation execution control unit.

8. The information processing apparatus according to claim 7, wherein said operation execution control unit outputs an advance notice signal to the outside at a timing when said digit-recurrence process ends and a rounding process starts,
wherein said advance notice signal indicates that an operation ends after a fixed time period passes.

9. The information processing apparatus according to claim 8, wherein said floating point divider further includes:
a determining unit configured to determine whether or not all bits of said partial remainder are bit values of 0,
wherein said operation execution control unit stops said digit-recurrence process and starts said rounding process when said all bits of said partial remainder are bit values of 0, based on a determining result of said determining unit.

10. The information processing apparatus according to claim 8, wherein said floating point divider further includes:
an unordinary number detecting unit configured to detect whether or not said input operand is an unordinary number,
wherein said operation execution control unit stops said digit-recurrence process and starts said rounding process when said input operand is detected as an unordinary number, based on a detecting result of said unordinary number detecting unit.

11. The information processing apparatus according to claim 7, wherein said mantissa repetitive processing unit includes:
a 1-bit left shifter configured to shift said partial remainder to the left by 1 bit,
a 2-bit left shifter configured to shift said partial remainder to the left by 2 bits,
a first selector configured to select one of said mantissa of said dividend, said partial remainder outputted from said 1-bit left shifter and said partial remainder outputted from said 2-bit left shifter as a first partial remainder, based on a selection signal,
a subtracter configured to execute a subtraction process based on said first partial remainder and a divisor of said input operand and output a carry bit and a subtraction result, and
a second selector configured to output one of said first partial remainder and said subtraction result as said partial remainder newly based on said carry bit to said 1-bit left shifter, said 2-bit left shifter and said operation execution control unit,
wherein said mantissa repetitive processing unit outputs said bit value at said specified position to said operation execution control unit based on said partial remainder, and
wherein said operation execution control unit generates said selection signal based on said bit value of said specified position and output said selection signal to said first selector.

12. The information processing apparatus according to claim 7, wherein said mantissa repetitive processing unit includes:
a 2-bit left shifter configured to shift said partial remainder to the left by 2 bits,
a 4-bit left shifter configured to shift said partial remainder to the left by 4 bits,
a first selector configured to select one of said mantissa of said dividend, said partial remainder outputted from said 2-bit left shifter and said partial remainder outputted from said 4-bit left shifter as a first partial remainder, based on a selection signal,
a first subtracter configured to execute a subtraction process based on said first partial remainder and a divisor of said input operand and output a first carry bit and a first subtraction result,
a second subtracter configured to execute a subtraction process based on said first partial remainder and a value that said divisor of said input operand is doubled and output a second carry bit and a second subtraction result,
a third subtracter configured to execute a subtraction process based on said first partial remainder and a value that said divisor of said input operand is tripled and output a third carry bit and a third subtraction result, and
a second selector configured to output one of said first partial remainder, said first subtraction result, said second subtraction result and said third subtraction result as said partial remainder newly based on said first carry bit, said second carry bit and said third carry bit to said 2-bit left shifter, said 4-bit left shifter and said operation execution control unit,
wherein said mantissa repetitive processing unit outputs said bit value at said specified position to said operation execution control unit based on said partial remainder, and
wherein said operation execution control unit generates said selection signal based on said bit value of said specified position and output said selection signal to said first selector.

13. A floating point dividing method, which is a binary digit-recurrence floating point dividing method, comprising:
calculating a quotient and a partial remainder by a digit-recurrence process for a mantissa of a dividend of an input operand; and
determining a bit value at a specified position uniquely specified based on a radix of an operation execution process with respect to said partial remainder,
reducing the number of digit-recurrence processes by calculating a quotient of which the number of bits is double of that of a quotient calculated once every said digit-recurrence process and a remainder on which the number of left-shift processes is double of that of a remainder calculated once every said digit-recurrence process, based on a determining result of said bit value at said specified position.

14. The floating point dividing method according to claim 13, further comprising:
outputting an advance notice signal to the outside at a timing when said digit-recurrence process ends and a rounding process starts,
wherein said advance notice signal indicates that an operation ends after a fixed time period passes.

15. The floating point dividing method according to claim 14, further comprising:
determining whether or not all bits of said partial remainder are bit values of 0, and
stopping said digit-recurrence process and starting said rounding process when said all bits of said partial remainder are bit values of 0, based on a determining result whether said all bits are bit values of 0.

16. The floating point dividing method according to claim 14, further comprising:
detecting whether or not said input operand is an unordinary number, and
stopping said digit-recurrence process and starting said rounding process when said input operand is detected as an unordinary number, based on a detecting result whether said input operand is an unordinary number.
